(19) United States
(12) Patent Application Publication
(10) Pub. No.: US 2008/0137189 A1
(43) Pub. Date: Jun. 12, 2008

(54) Conversion of the polarization of light via a composite half-wave plate

(75) Inventor: Chun-Ching Shih, Palos Verdes Estates, CA (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Northrop Grumman SPace & MIssion Systems Corporation

(21) Appl. No.: 11/637,289

(22) Filed: Dec. 12, 2006

(51) Int. Cl. G02B 27/28

(52) U.S. Cl. 359/489; 359/483

(57) ABSTRACT

Systems and methods for converting linearly polarized light to azimuthally or radially polarized light. A composite half-wave plate assembly includes a plurality of angular half-wave plate sections. Each of the plurality of angular half-wave plate sections have two congruent sides that meet at an apex. The plurality of half-wave plates are arranged such that the apexes of the plurality of angular half-wave plate sections all meet at a point substantially at a center of the composite half-wave plate, and a characteristic c-axis associated with a given angular half-wave plate section is aligned differently from the respective characteristic c-axes of at least two angular half-wave plate sections in substantial contact with the two sides of the given angular half-wave plate section. A fixation element engages the plurality of angular half-wave plate sections to maintain the angular half-wave plate sections in a desired arrangement.

### CROSS REFERENCE TO RELATED APPLICATIONS

This application is related to the following commonly assigned co-pending patent application entitled: “Optical Birefringence Coronagraph,” Attorney Docket No. NG(ST)8395; which is being filed contemporaneously herewith and is incorporated herein by reference.

### TECHNICAL FIELD

The present invention relates generally to optical technology, and more particularly to system for converting linearly polarized light to another orientation via a composite half-wave plate.

### BACKGROUND OF THE INVENTION

A laser beam of radial or azimuthal polarization has attracted great attention recently due to its wide applications, including communications, material processing, optical trapping, and optical acceleration. It was first recognized that a radially polarized beam can be generated from a laser resonator with an intra-cavity conical Brewster window. However, it is generally not easy to control the resonator mode in such cavities and it might have certain advantages to generate the radially/azimuthally polarized beam external to the cavity. One approach is to combine two specially prepared beams to become a single radially polarized beam. Those two individual beams are generated with diffractive optical elements. As a result, the scheme is complicated and not very efficient.

### SUMMARY OF THE INVENTION

In accordance with an aspect of the present invention, a composite half-wave plate assembly includes a plurality of angular half-wave plate sections. Each of the plurality of angular half-wave plate sections have two congruent sides that meet at an apex. The plurality of half-wave plates are arranged such that the apexes of the plurality of angular half-wave plate sections all meet at a point substantially at a center of the composite half-wave plate, and a characteristic c-axis associated with a given angular half-wave plate section is aligned differently from the respective characteristic c-axes of at least two angular half-wave plate sections in substantial contact with the two sides of the given angular half-wave plate section. A fixation element engages the plurality of angular half-wave plate sections to maintain the angular half-wave plate sections in a desired arrangement.

In accordance with another aspect of the present invention, a method for creating a composite half-wave plate is provided. At least one half-wave plate is divided into a plurality of angular sections. The plurality of angular sections are arranged into a desired arrangement as a composite half-wave plate, such that linearly polarized light passing through composite half-wave plate is converted to one of an azimuthal, a radial, and a random polarization. The plurality of angular sections are mechanically fixed in the desired arrangement.

In accordance with yet another aspect of the present invention, an apparatus is provided for generating a beam of light having one of an azimuthal polarization, a radial polarization, and a mixed polarization. A light source generates a linearly polarized beam of light. A composite half-wave plate includes a plurality of angular half-wave plate sections. Each of the plurality of angular half-wave plate sections have two congruent sides that meet at an apex. The plurality of half-wave plates are arranged such that the apexes of the plurality of angular half-wave plate sections all meet at a point substantially at a center of the composite half-wave plate. A characteristic c-axis associated with a given angular half-wave plate section is aligned differently from the respective characteristic c-axes of at least two angular half-wave plate sections in substantial contact with the two sides of the given angular half-wave plate sections. The composite half-wave plate is positioned in the path of the generated beam of light such that the beam of light passes through the composite half-wave plate

### BRIEF DESCRIPTION OF THE DRAWINGS

FIG. 1 illustrates an exemplary composite half-wave plate in accordance with an aspect of the present invention.

FIG. 2 provides a graphic illustration of a first exemplary process for creating a composite half-wave plate in accordance with an aspect of the present invention

FIG. 3 provides a graphic illustration of a second exemplary process for creating a composite half-wave plate in accordance with an aspect of the present invention.

FIG. 4 illustrates a system utilizing a composite half-wave plate for generating a light beam of mixed polarization in accordance with an aspect of the present invention.

### DETAILED DESCRIPTION OF INVENTION

In order to convert a linearly polarized beam into a radially/azimuthally polarized beam effectively, this invention employs the concept of orientation-independent polarization rotator using a half-wave plate having a characteristic c-axis, that is an axis in a birefringent material along which the electric field portion of electromagnetic field radiation experiences extraordinary index of refraction. When passing through a half-wave plate, a linearly polarized beam will have its polarization changed to the other side of the c-axis. Mathematically, it can be written as a′=2b−a, where b is the angle of the c-axis, a and a′ are the polarization angles of the input and output beams. This concept can be used to convert a linearly polarized beam into a “nearly” radially or azimuthally polarized beam. To this end, a composite half-wave plate can be utilized that represents an azimuthal variation of the c-axis representing a full cycle of rotation. Since the output polarization angle rotates twice as fast as the c-axis angle, a linearly polarized input beam will be converted by a single cycle composite half-wave plate into a beam of radial or azimuthal polarization, or a combination thereof, depending on the orientation of the input polarization. The composite half-wave plate provides high throughput and preserves an intensity profile of the linearly polarized beam.

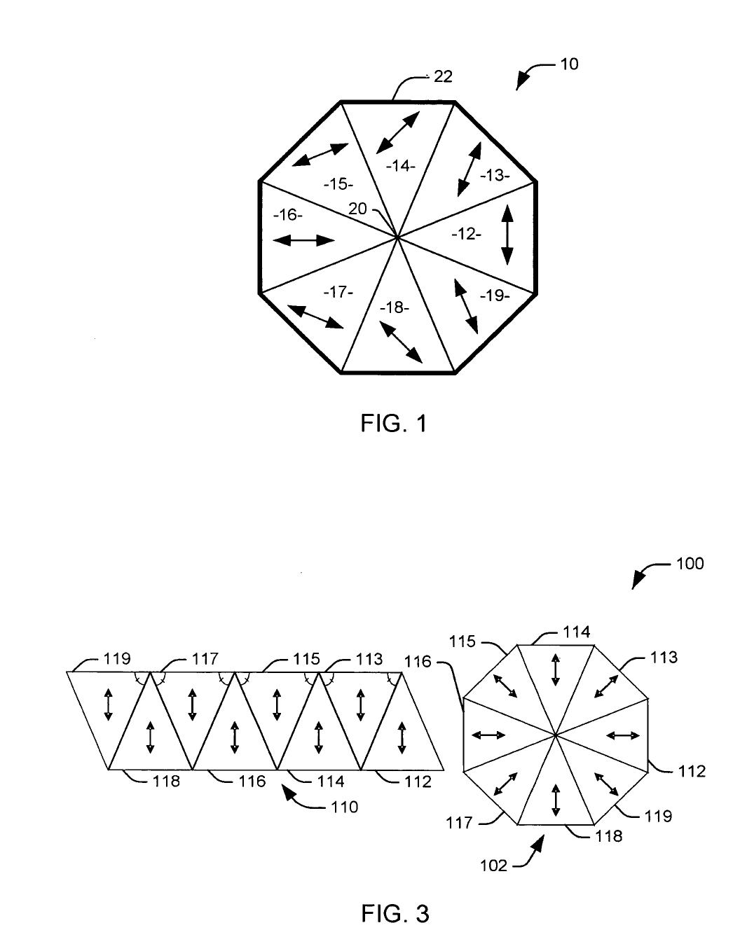

FIG. 1 illustrates an exemplary composite half-wave plate 10 that is comprised of a number of angular half-wave plate sections 12-19 that are aligned to have varying c-axis angles. The illustrated half-wave plate 10 comprises eight angular sections 12-19, but it will be appreciated that more or fewer angular sections can be utilized in accordance with an aspect of the present invention. Each angular section 12-19 has two congruent sides meeting at an apex. An outer edge of each angular sections 12-19 can take on any reasonable contour, such as an arc, a straight line, or multiple straight or curved lines, such that the angular sections are roughly triangular. The angular sections 12-19 are configured such that the apex of each angular section meets at or near a central point 20 of the half-wave plate 10. In accordance with an aspect of the present invention, the angular sections 12-19 comprising the half-wave plate 10 can be configured such that the passage of linearly polarized light through the half wave plate is converted to a radial or azimuthal orientation. To this end, the angular sections 12-19 comprising the half-wave plate can be selected such that the c-axis associated with each section can rotate by a predetermined amount at each successive section, such that the characteristic c-axis of a given angular section (e.g., 13) is different from the characteristic c-axes of the angular sections to either side (e.g., 12 and 14).

The angular sections 12-19 can be held in place by a fixation element 22 that holds the angular sections in place relative to one another. It will be appreciated that the fixation element 22 can comprise any suitable means for holding the angular sections 12-19 in place without interfering with the passage of light through the surface of the half-wave plate 10. For example, the fixation element 22 can include one or more of an adhesive, a rigid outer rim that mechanically precludes movement of the angular sections, or a frame operative to mechanically communicate with the angular sections 12-19 as to hold them in place. In the illustrated example of a half-wave plate 10, the fixation element 22 is illustrated as an outer frame that mechanically engages the angular sections 12-19, but it will be appreciated that this is merely exemplary.

In the illustrated example, the c-axes associated with the various angular sections 12-19 are selected such that the collective effect of the angular half-wave plate sections is the conversion of a linearly polarized light beam into a radially or azimuthally polarized light beam. Specifically, the c-axes associated with the various angular sections 12-19 are selected such that one cycle of rotation is observed in the represented c-axes of angular sections. For example, envision a coordinate system in which the direction of propagation for a beam of light is the z-axis, the y-axis is vertical relative to the illustrated orientation of the half-wave plate 10, and the x-axis is horizontal relative to the illustrated orientation of the half-wave plate. When a light beam that is linearly polarized along the x-axis is directed at the surface of the illustrated half-wave plate, a radially polarized light beam is produced. Similarly, when a light beam that is linearly polarized along the y-axis is directed at the surface of the illustrated half-wave plate, an azimuthally polarized light beam is produced. Since the angular sections 12-19 comprising the composite half-wave plate 10 extend to the center of the plate, the plate can be utilized to convert the entirety of a light beam, including a central region, into an azimuthal or radial polarization. In addition, the step-wise change of polarization direction between neighboring sections has negligible effects on the subsequent propagation or focusing property of the beam.

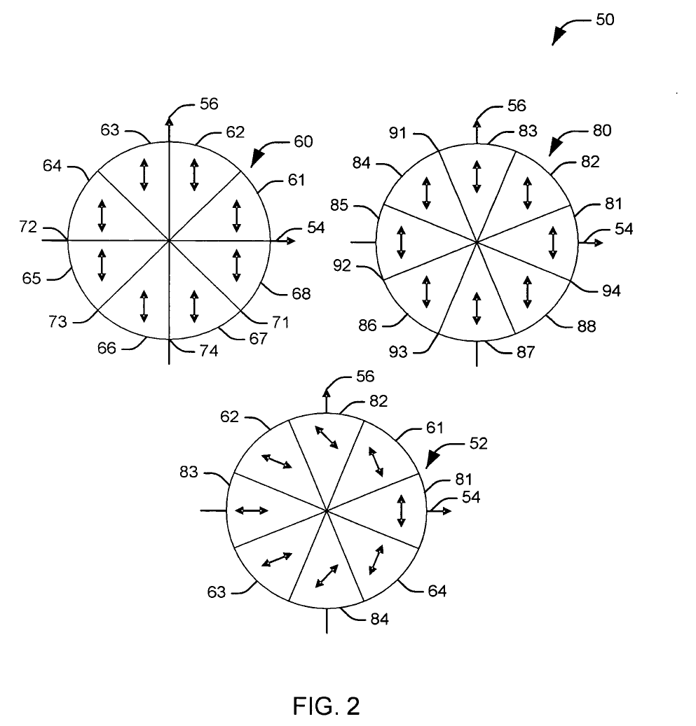

FIG. 2 provides a graphic illustration 50 of a first exemplary process for creating a composite half-wave plate 52 in accordance with an aspect of the present invention. To better illustrate the process, a common coordinate axis is utilized, comprising a horizontal axis 54 and a vertical axis 56. In the common coordinate axis, the positive end of the horizontal axis 54 represents zero degrees and the positive end of the vertical axis 56 represents ninety degrees. The composite half-wave plate 52 is comprised of a plurality of angular sections from a first circular half-wave plate 60, comprising a first plurality of angular sections 61-68 generated by a first plurality of straight line divisions 71-74 made along diameters of the first circular half-wave plate, and a second circular half-wave plate 80, comprising a plurality of angular sections 81-88 generated by a second plurality of straight line divisions 91-94 made along diameters of the second circular half-wave plate. For the purpose of example, both plates 60 and 80 have a c-axis aligned with the vertical axis 62. It will be appreciated that the divisions can be made by any appropriate mechanism for cutting or otherwise separating birefringent materials.

In the first half-wave plate 60, the angular divisions 71-74 can comprise a first division 71 at 135°, a second division 72 along the horizontal axis, a third division 73 at 45°, and a fourth division 74 along the vertical axis. In the second half-wave plate 80, the angular divisions 91-94 can comprise a first division 91 at 112.5°, a second division 92 at 22.5°, a third division 93 at 67.5°, and a fourth division 94 at 157.5°. Accordingly, eight segments, each taking in forty-five degrees of arc, are generated, and segments from the two half-wave plates 60 and 80 are offset by 22.5°. Speaking generally, for N divisions, angular sections encompassing 180/N degrees of arc will be formed, and angular sections from the two half-wave plates 60 and 80 will be offset by 90/N degrees. Once the two half-wave plates 60 and 80 have been segmented into their respective plurality of angular sections 61-68 and 81-88, the angular sections from the two plates can be rearranged to form the composite plate.

To achieve the desired c-axis rotation within the composite half-wave plate 52, a selected subset of angular sections 61-64 and 81-84 are utilized to create the composite plate. A first angular section from the second half-wave plate 80 is centered on the positive end of the horizontal axis, at the same position as it inhabited in the second half-wave plate. A first angular section 61 from the first half-wave plate 60 is placed on the counterclockwise edge of the previous angular section 81, in a position shifted 22.5° counterclockwise from its original position in the first half-wave plate. A second angular section 82 from the second half-wave plate 80 is placed on the counterclockwise edge of the previous angular section 61, at a position 45° from its original position in the second half-wave plate. Similarly, a second angular section 62 from the first half-wave plate 60 is placed on the counterclockwise edge of the previous angular section 81, at a position 67.5° from its original position in the first half-wave plate. This continues, with the segment to be placed next being selected to ensure a 22.5° rotation of the c-axis associated with each successive segment. The final segment 64 is placed at a position 157.5° from its original position, such that the c-axis rotates a complete cycle in one circuit around the composite half-wave plate 52. In other words, the c-axis of the first angular half-wave plate section 81 represents a first angle and the c-axis of a fifth angular half-wave plate section 83 that is opposite the first angular half-wave plate section represents a second angle substantially perpendicular to the first angle. Once the angular sections 61-64 and 81-84 are arranged in the desired manner, they are mechanically fixed into place via an appropriate fixation element (e.g., a frame, an adhesive, etc.).

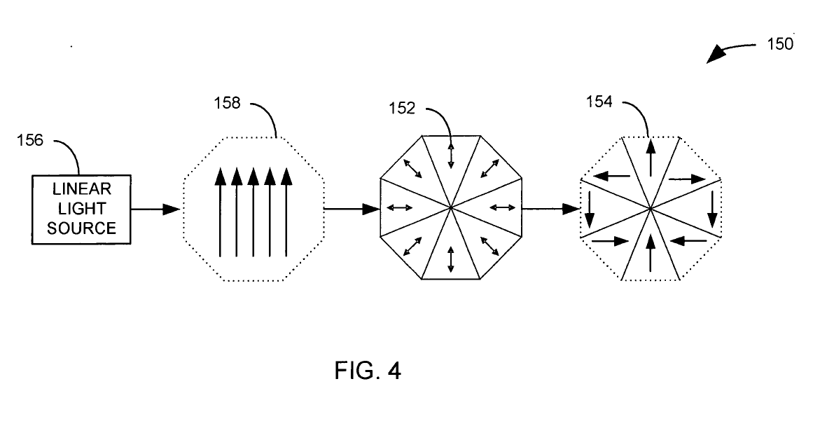

FIG. 3 provides a graphic illustration 100 of a second exemplary process for creating a composite half-wave plate 102 in accordance with an aspect of the present invention. In accordance with an aspect of the present invention, a parallelogram-shaped piece of birefringent material 110 can be divided into a plurality of angular half-wave plate sections 112-119. In the illustrated example, the angular half-wave plate sections 112-119 are divided via a plurality of cuts, each making about a 67.5° angle with the upper parallel edge of the parallelogram. The resulting angular half-wave sections are shaped as isosceles triangles. The cuts can be conceptualized as two sets of parallel cuts, with a first set of parallel cuts running from left to right from the bottom parallel edge of the parallelogram to the top parallel edge, and a second set of parallel cuts running right to left from the bottom edge to the top edge.

The triangular sections 112-119 can then be placed together form an octagonal pattern, with the vertex between the two contiguous sides of each isosceles triangles being oriented toward the center of the octagon, such that the respective vertices associated with the plurality of angular half-wave plate sections 112-119 are in mutual contact. In the resulting pattern, the c-axis associated with the plurality of angular half-wave plate sections 112-119 rotates two complete cycles in one circuit around the half-wave plate 102. In other words, the c-axis of the first angular half-wave plate section 112 represents a first angle and the c-axis of a fifth angular half-wave plate section 116 that is opposite the first angular half-wave plate section represents a second angle substantially equal to the first angle. Once the angular sections 112-119 are arranged in the desired manner, they are mechanically fixed into place via an appropriate fixation element (e.g., a frame, an adhesive, etc.).

It will be appreciated that the composite half-wave plate 102, since it represents two complete cycles of rotation of the c-axis, would not be used for generating radial or azimuthal polarizations of light. Instead, linearly polarized light passing through the half-wave plate 102 would assume a mixed polarization state, where the polarization of the light demonstrates an azimuthal variation of two or more complete cycles within the beam. This can be better understood with reference to FIG. 4, which illustrates a system 150 utilizing a composite half-wave plate 152 for generating a light beam of mixed polarization 154 in accordance with an aspect of the present invention.

A linear light source 156 produces a beam of linearly polarized light 158. The composite half-wave plate 152 is positioned in the path of the beam of linearly polarized light 158 such that the beam of linearly polarized light passed through the half-wave plate. In accordance with an aspect of the present invention, the composite half-wave plate 152 is constructed as to exhibit two complete cycles of the c-axis in a circumscription of the plate. It will be appreciated, however, that the axis of polarization of the linear light source 156 and the construction of the half-wave plate 152 could be altered to allow for the generation of azimuthally or radially polarized light with a similar arrangement. The polarization of the light is changed by its passage through the half-wave plate 158 such that the beam 158 assumes a mixed polarization state. In the illustrated example, the polarization of the light in the mixed polarization state demonstrates an azimuthal variation of two complete cycles within the beam 158.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

Having described the invention, the following is claimed:

1. A composite half-wave plate assembly comprising:
a plurality of angular half-wave plate sections, each of the plurality of angular half-wave plate sections having two congruent sides that meet at an apex, the plurality of half-wave plates being arranged such that the apexes of the plurality of angular half-wave plate sections all meet at a point substantially at a center of the composite half-wave plate, and a characteristic c-axis associated with a given angular half-wave plate section is aligned differently from the respective characteristic c-axes of at least two angular half-wave plate sections in substantial contact with the two sides of the given angular half-wave plate section; and
a fixation element that engages the plurality of angular half-wave plate sections to maintain the angular half-wave plate sections in a desired arrangement.

2. The assembly of claim 1, wherein the plurality of angular half-wave plate sections are arranged such that linearly polarized light passing through the composite half-wave plate is converted to one of an azimuthal polarization and a radial polarization.

3. The assembly of claim 1, wherein the plurality of angular half-wave plates are arranged such that a characteristic c-axis of a given angular half-wave plate section is rotated clockwise by a predetermined amount relative to a first of the at least two angular half-wave plate sections and rotated counterclockwise by the predetermined amount relative to a second of the at least two angular half-wave plate sections.

4. The assembly of claim 1, wherein the plurality of angular half-wave plates are arranged such that the characteristic c-axes of the plurality of angular half-wave plate sections represent a rotation through one full cycle, such that the characteristic c-axis of a first angular half-wave plate section represents a first angle and the characteristic c-axis of a second angular half-wave plate section that is opposite the first angular half-wave plate section on the composite half-wave plate represents a second angle substantially perpendicular to the first angle.

5. The assembly of claim 1, wherein the plurality of angular half-wave plates are arranged such that the characteristic c-axes of the plurality of angular half-wave plate sections represent a rotation through two full cycles, such that the characteristic c-axis of a first angular half-wave plate section represents a first angle and the characteristic c-axis of a second angular half-wave plate section that is opposite the first angular half-wave plate section on the composite half-wave plate represents a second angle substantially equal to the first angle.

6. The assembly of claim 1, wherein the fixation element comprises a rigid outer rim that mechanically precludes movement of the angular half-wave plate sections.

7. The assembly of claim 1, wherein the fixation element comprises a frame operative to mechanically communicate with the angular half-wave plate sections as to hold them in place.

8. The assembly of claim 1, wherein the fixation element comprises an adhesive.

9. An optical communications system comprising the composite half-wave plate assembly of claim 1.

10. A method for creating a composite half-wave plate comprising:
dividing at least one half-wave plate into a plurality of angular sections;
arranging the plurality of angular sections into a desired arrangement as a composite half-wave plate, such that linearly polarized light passing through composite half-wave plate is converted to one of an azimuthal, a radial, and a random polarization; and
mechanically fixing the plurality of angular sections in the desired arrangement.

11. The method of claim 10, wherein the at least one half-wave plate comprises a single half-wave plate in the shape of a parallelogram comprising first and second parallel boundaries and dividing the at least one half-wave plate comprises making a first set of parallel divisions from the top of the plate to the bottom of the plate at a first angle relative to the first parallel boundary and making a second set of parallel divisions from the top of the plate to the bottom of the plate at a second angle relative to the first parallel boundary.

12. The method of claim 11, wherein no division from the first set of parallel divisions intersects a division from the second set of parallel divisions at any point other than the first and second parallel boundaries.

13. The method of claim 11, wherein the first angle and the second angle are congruent and each of the first set of divisions intersects at least one of the second set of parallel divisions at one of the first and second parallel boundaries, such that each of the plurality of angular sections is shaped as an isosceles triangle.

14. The method of claim 10, wherein the at least one half-wave comprises a first circular half-wave plate that is divided to generate a first set of angular sections and a second circular half-wave plate that is divided to generate a second set of angular sections, and dividing a given circular half-wave plate into a set of angular sections comprises dividing the circular half-wave plate among N diameters of the circular half-wave plate, where N is an integer greater than one and the at least two diameters are evenly spaced such that each angular section takes a portion of the arc of the circle equal, in degrees, to one-hundred eighty divided by N.

15. The method of claim 14, wherein the composite half-wave plate is comprised of a subset of the first set of angular sections and a subset of the second set of angular sections, such that at least one angular section from the first set of angular sections and at least one angular section from the second set of angular sections are not part of the plurality of angular sections arranged as part of the composite half-wave plate.

16. The method of claim 14, wherein the first set of angular sections and the second set of angular sections are arranged alternately, such that a given angular section from the first set of angular sections will be situated between two angular sections from the second set of angular sections, and a given angular section from the second set of angular sections will be situated between two angular sections from the first set of angular sections.

17. The method of claim 14, wherein each of the N diameters associated with the first circular half-wave plate is offset by 90/N degrees from a corresponding diameter associated with the second circular half-wave plate.

18. An apparatus for generating a beam of light having one of an azimuthal polarization, a radial polarization, and a mixed polarization, comprising:
a light source that generates a linearly polarized beam of light; and
a composite half-wave plate that comprises a plurality of angular half-wave plate sections, each of the plurality of angular half-wave plate sections having two congruent sides that meet at an apex, the plurality of half-wave plates being arranged such that the apexes of the plurality of angular half-wave plate sections all meet at a point substantially at a center of the composite half-wave plate, and a characteristic c-axis associated with a given angular half-wave plate section is aligned differently from the respective characteristic c-axes of at least two angular half-wave plate sections in substantial contact with the two sides of the given angular half-wave plate sections, the composite half-wave plate being positioned in the path of the generated beam of light such that the beam of light passes through the composite half-wave plate.

19. The apparatus of claim 18, wherein the composite half-wave plate comprises a fixation element that engages the plurality of angular half-wave plate sections to maintain the angular half-wave plate sections in a desired arrangement

20. The apparatus of claim 18, wherein the plurality of angular half-wave plates are arranged such that a characteristic c-axis of a given angular half-wave plate section is rotated clockwise by a predetermined amount relative to a first of the at least two angular half-wave plate sections and rotated counterclockwise by the predetermined amount relative to a second of the at least two angular half-wave plate sections.

21. An optical trapping assembly comprising the apparatus of claim 18.
